(19) United States
(12) Patent Application Publication
(10) Pub. No.: US 2010/0172761 A1
(43) Pub. Date: Jul. 8, 2010

(54) METHOD OF FABRICATING A TURBOMACHINE COMPRESSOR DRUM

(75) Inventor: Stevan Le Goff, Vaux Le Penil (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SNECMA, Paris (FR)

(21) Appl. No.: 12/573,265

(22) Filed: Oct. 5, 2009

(30) Foreign Application Priority Data
Jan. 6, 2009 (FR) 09 00023

(51) Int. Cl. F04D 29/00; B23P 15/00

(52) U.S. Cl. 416/198 A; 29/888.02

(57) ABSTRACT

A method of fabricating a turbomachine compressor drum comprising at least one rotor disk connected to an annular flange on the same axis via a wall of revolution, the method consisting in making said wall of revolution with a local annular extra thickness of material, and then once said wall of revolution has become deformed in use, in cutting through the extra thickness and in removing the wall, in positioning a new wall of revolution to take the place of the removed wall, and in welding the new wall to the drum.

### FIELD OF THE INVENTION

The present invention relates to a method of fabricating a turbomachine compressor drum, the drum being of the type comprising at least two rotor disks on a common axis that are connected together and to an annular flange on the same axis via substantially cylindrical or frustoconical walls forming bodies of revolution.

### BACKGROUND OF THE INVENTION

A high-pressure compressor of a turbomachine may include one or two drums of this type. A drum may have three, four, five, or even more rotor disks that are connected to one another by walls forming bodies of revolution, referred to herein as “walls of revolution” for short, the drum also including respective annular flanges at each of its axial ends for fastening to another rotor disk and/or to another drum. These flanges are connected to the furthest upstream and downstream rotor disks of the drum by two other respective walls of revolution.

Groups of annular wipers are formed on each wall of revolution of the drum. These wipers extend radially outwards and rub against blocks of abradable material carried by the stator of the turbomachine so as to form labyrinth type sealing gaskets.

It is found that certain drums, in particular those made of titanium, are subjected to large amounts of creep in operation. The downstream wall of revolution connecting the furthest downstream disk of a drum to its downstream fastener flange is exposed to high temperatures in operation (of the order of 500° C.) and it suffers high levels of deformation in creep that give rise to said wall swelling outwards. This has the particular consequence of the annular wipers on said wall being moved radially outwards, and that can modify the flow rate of leakage air through the corresponding labyrinth seal.

It is not possible at present to repair a turbomachine drum that has suffered this type of deformation, so the entire drum needs to be rejected and replaced by a new drum, which is very expensive.

### OBJECT AND SUMMARY OF THE INVENTION

A particular object of the invention is to provide a method of fabricating a drum that enables a new drum to be made from a drum having a wall of revolution that has suffered deformation in operation.

To this end, the invention provides a method of fabricating a turbomachine compressor drum comprising at least two rotor disks on a common axis connected to each other and to an annular flange on the same axis by substantially cylindrical or frustoconical walls of revolution, wherein the method comprises the steps consisting in:

making the wall of revolution interconnecting one of the disks and the annular flange so that it has a local annular extra thickness of material;

then, once said wall of revolution has become deformed in use, cutting through the extra thickness and removing the wall; and

positioning a new wall of revolution to take the place of the removed wall, and welding said new wall to the drum.

The method of the invention essentially comprises three steps: the first step consists in providing a local annular extra thickness of material in the wall of revolution of the drum connecting a flange to a rotor disk, the second step consists in cutting through the extra thickness to cut off the wall of revolution of the drum that has suffered deformation and in removing said wall, and the third step consists in welding a new wall to the drum.

The method of fabrication thus enables a new drum to be obtained from a drum that has suffered deformation. It is therefore no longer necessary to replace the deformed drum with the new drum, thus saving expense.

The local extra thickness of material is provided in the wall of revolution of the drum on initial fabrication of the drum so as to make possible subsequent operations of cutting off the wall in the event of it becoming deformed and welding on a replacement wall. This extra thickness serves to reinforce and stiffen the zone of the wall that is subjected to relatively high levels of thermal, mechanical, and vibratory stresses during cutting and welding operations.

An extra thickness is formed on the or each wall that is likely to deform in operation, and thus preferably on the wall of revolution of the drum that connects the downstream rotor disk to the downstream fastener flange. It is also possible to provide an extra thickness of material on any other wall of revolution of the drum. Each wall of revolution of the drum may also have a plurality of annular extra thicknesses of material of this type.

Advantageously, the method consists in cutting the deformed wall in the middle of the local extra thickness, and in replacing it with a new wall that likewise includes a local extra thickness, in order to withstand the thermal stresses associated with the welding operation.

The new wall may be welded to the drum by inertia friction welding or by electron beam welding, or by any other suitable technique.

In addition, before or after the step of welding the wall, the method of the invention may also include a step consisting in machining the new wall so as to form thereon external annular wipers of a labyrinth seal.

Advantageously, after the welding step, the method may include a step consisting in machining the welded zone so that its radial thickness is substantially equal to the radial thickness of the remainder of the wall.

When it is the downstream wall of revolution of the drum that needs to be repaired, this wall has outer annular wipers and the extra thickness is situated between those wipers and a rotor disk.

The present invention also provides a turbomachine compressor drum comprising at least two rotor disks on a common axis connected to each other and to an annular flange on the same axis via substantially cylindrical or frustoconical walls of revolution, wherein the wall of revolution connecting one of the disks to the annular flange includes at least one local annular extra thickness of material, through which the drum can be cut in the event of said wall becoming deformed, in order to remove and replace the wall.

For a turbomachine high-pressure compressor, this drum is made in particular out of titanium.

Advantageously, the extra thickness is situated between a rotor disk and outer annular wipers formed on the wall of revolution.

The extra thickness may have radial thickness lying in the range about 6 millimeters (mm) to 10 mm. The radial thickness of the remainder of the wall is of the order of about 2 mm to 3 mm.

Finally, the invention provides a turbomachine, such as an airplane turboprop or turbojet, wherein the turbomachine includes a compressor drum as described above.

### BRIEF DESCRIPTION OF THE DRAWINGS

The invention can be better understood and other details, characteristics, and advantages of the present invention appear more clearly on reading the following description made by way of non-limiting example and with reference to the accompanying drawings, in which:

FIG. 1 is a fragmentary diagrammatic half-view in axial section of a high-pressure compressor of a turbomachine, the compressor including two drums;

FIG. 2 is a fragmentary view on a larger scale of detail I of FIG. 1, and shows the downstream wall of revolution of the upstream drum of the compressor; and

FIGS. 3 to 6 show steps in the method of the invention for repairing a turbomachine compressor drum.

### MORE DETAILED DESCRIPTION

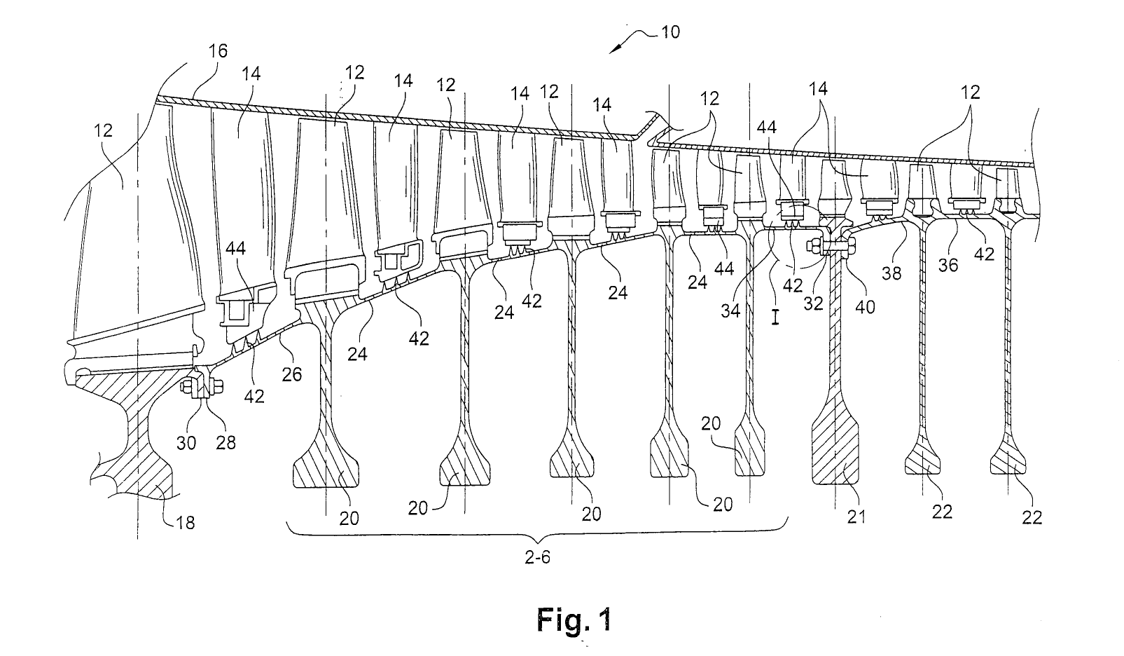

The high-pressure compressor 10 of a turbomachine as shown in FIG. 1 comprises a plurality of compression stages, each of these stages comprising an annular row of rotor blades 12 and associated with an annular row of stator vanes 14 for flow-straightening and located downstream from the corresponding row of blades 12.

The radially outer ends of the vanes 14 are carried by a substantially cylindrical outer annular casing 16 of the compressor.

At their radially inner ends, the blades 12 have roots that are mounted in axial slots or in radial grooves formed in the outer peripheries of rotor disks 18, 20, 21, and 22.

Five rotor disks 20 are connected to one another along a common axis by walls 24 constituting substantially cylindrical or frustoconical bodies of revolution so as to constitute a front or upstream first drum of the rotor, comprising the rotor disks of stages 2 to 6 of the compressor and referred to as the “2-6 drum”.

The upstream drum 20 of the 2-6 drum (corresponding to the second stage of the compressor) includes an upstream substantially frustoconical wall of revolution 26 that has its upstream end connected via a fastener flange 28 to a corresponding annular flange 30 of the disk 18 of the first stage of the compressor. The flanges 28 and 30 are held clamped axially one against the other by screw-and-nut type means.

The downstream disk 20 of the 2-6 drum (corresponding to the sixth stage of the compressor) has a substantially cylindrical downstream wall of revolution 32 with a downstream end that includes an annular flange 34 pressed and clamped against the upstream face of the disk 21 of the seventh stage of the compressor.

The downstream rotor disks 22 are connected to one another by walls of revolution 36 so as to form a rear or downstream drum. The upstream disk of this drum (corresponding to the eighth stage of the compressor) includes a substantially cylindrical upstream wall of revolution 38 with an upstream end that has an annular flange 40 pressed and clamped against the downstream face of the disk 21 by screw-and-nut means.

Each drum is generally made up by assembling rotor disks and walls of revolution together, e.g. by welding (electron beam welding or inertia friction welding). The 2-6 drum may be made of titanium and the other drum may be made of an alloy based on nickel or cobalt.

The walls of revolution 24, 26, 32, 36, and 38 all include, substantially in register with the annular rows of vanes 14, annular wipers 42 that extend radially outwards from the outside surfaces of the walls. These wipers 42 are designed to rub against annular elements 44 of abradable material that are secured to the inner peripheries of the vanes 14 so as to form labyrinth type seals.

These seals limit the passage of hot air from the flowsection of the compressor in an axially upstream or downstream direction through the annular spaces situated between the inner peripheries of the rows of vanes and the walls of revolution 24, 26, 32, 36, and 38.

In operation, the walls of revolution of the drums (and in particular the wall 32 connecting the downstream disk 20 of the 2-6 drum to the flange 34) tend to deform by creep as a result of the high temperatures to which they are subjected.

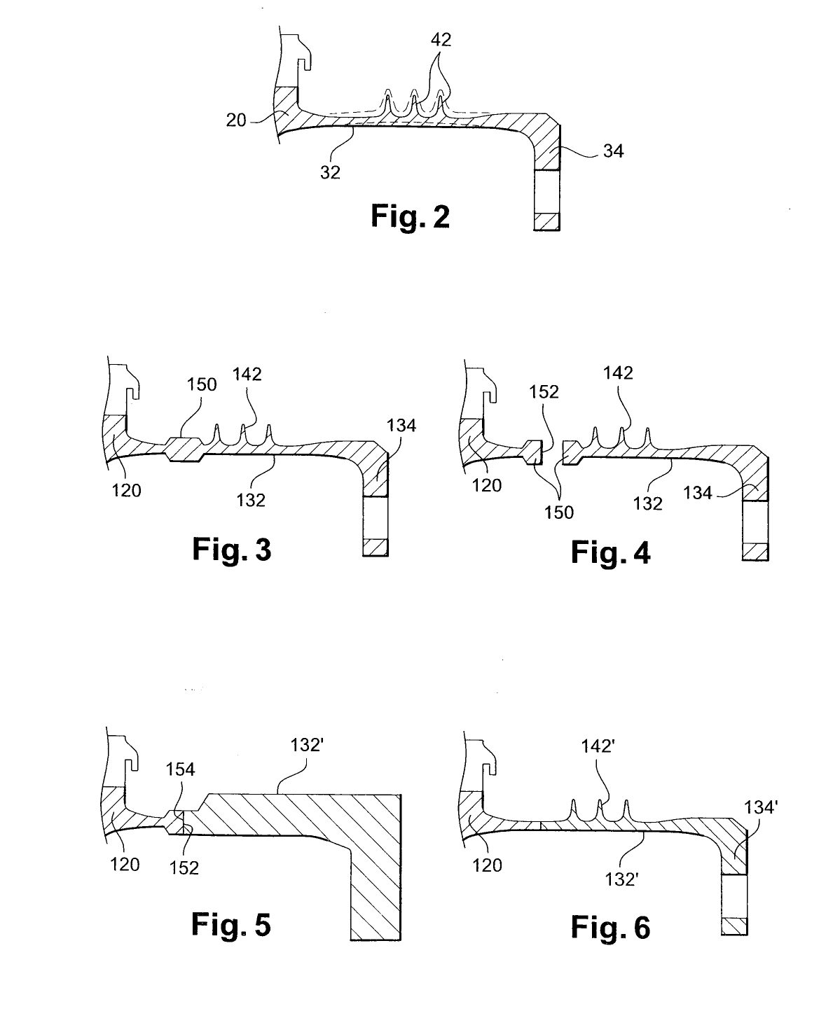

FIG. 2 is a view on a larger scale of the downstream wall 32 of this disk. The position of the wall 32 in the non-deformed state is drawn in continuous lines and the position of said wall after deformation is drawn in dashed lines. It can be seen that this wall is subjected in operation to radially outward deformation or “swelling”, which normally gives rise to the wipers 42 of said wall 32 moving radially outwards.

In the prior art, a drum presenting this type of deformation is rejected and needs to be replaced with a new drum.

The present invention proposes a solution that is more economical by providing a drum that can be repaired, its deformed wall being replaced by a new wall.

For this purpose, at least one wall of revolution of the drum of the invention is made with an annular extra thickness of material, this wall being designed to be cut through in its extra thickness in order to remove the wall and replace it with a new wall. The plane through which the wall is cut extends perpendicularly to the longitudinal axis of the turbomachine, and the cutting is performed all around the circumference of the wall.

The end of the new wall is then welded to the cut end of the drum. The extra thickness of material initially provided on the wall of the drum is of a shape and of dimensions that are determined so that this wall can withstand the stresses associated with the above-described cutting and welding operations.

When it is desired to repair the downstream wall of revolution 32 of the 2-6 drum, the wall needs to include annular extra thickness 150, as shown in FIG. 3.

In the example shown, this extra thickness 150 is situated between the disk 120 and the wipers 142, and thus extends between the downstream zone of the wall 132 that is subjected to deformation in operation, and the upstream zone of the wall that is connected to the disk and that is more rigid.

The extra thickness 150 presents a radial thickness that is equal to or greater than about twice the thickness of the remainder of the wall 132. The radial thickness of the extra thickness lies for example in the range 6 mm to 10 mm, while the thickness of the remainder of the wall may be of the order of about 3 mm. The axial dimension of the extra thickness lies in the range about 10 mm to 20 mm.

As can be seen in FIG. 3, this extra thickness 150 is situated at a distance from the axial ends of the wall 132. It is formed integrally with the wall and it is obtained by casting or machining at the same time as the wall is obtained.

The invention proposes a method of fabricating a drum of the above type, comprising steps that are represented diagrammatically by FIGS. 3 to 6.

The method comprises essentially three steps: a first step in which at least one of the walls of revolution 132 of the drum is made with local annular extra thickness 150, a second step in which said wall is cut through in its extra thickness 150 and the wall 132 is removed, and a third step in which a new annular wall 132′ is welded to the drum.

In the implementation represented by FIGS. 3 to 6, the first step of the method is shown in FIG. 3 and the second step in FIG. 4. The second step consists in cutting the wall 132 through the extra thickness 150 of the damaged wall of revolution 132, substantially through the middle thereof and around its entire circumference, and then in removing the wall 132. Cutting may be performed using any suitable tool, for example parting on a lathe. The third step of the method as represented by

FIG. 5 consists in welding an axial end 154 of a new wall 132′ to the cut end 152 of the drum.

The welding may be performed by inertia friction welding or by electron beam welding, which are well known to the person skilled in the art and are not described in detail below.

In the implementation shown, the new wall 132′ is a blank that is subsequently machined so as to form thereon wipers 142′ and an annular flange 134′ that are identical to those of the wall 132.

The end 154 for welding of the new wall 132′ has a radial thickness equivalent to that of the extra thickness 150, in particular so as to be able to withstand the thermal stresses associated with welding.

After the welding operation, the wipers 142′ and the flange 134′ are machined, as mentioned above, and the welded ends 152, 154 of the drum and the wall 132′ are also machined so that their radial thicknesses are substantially equal to those of the remainder of the wall.

In a variant, these welded ends are not machined, thereby ensuring that they conserve sufficient radial thickness to enable them to be subjected to new cutting and welding operations, where appropriate, should the wall 132′ in turn become deformed after being used for a certain length of time.

The drum may include one or more annular extra thicknesses 150 of the above-described type. Furthermore, a single wall of revolution of the drum may include two extra thicknesses 150 that are spaced apart from each other and that are designed to be cut through in order to remove and replace the wall portion that extends between said two extra thicknesses.

The method of the invention may be applied to other types of turbomachine drum, such as a double blisk drum, i.e., a drum having two one-piece bladed disks on a common axis and interconnected by a substantially cylindrical or frustoconical wall of revolution.

What is claimed is:

1. A method of fabricating a turbomachine compressor drum comprising at least two rotor disks on a common axis connected to each other and to an annular flange on the same axis by substantially cylindrical or frustoconical walls of revolution, wherein the method comprises the steps consisting in:
making the wall of revolution interconnecting one of the disks and the annular flange so that it has a local annular extra thickness of material;
then, once said wall of revolution has become deformed in use, cutting through the extra thickness and removing the wall; and
positioning a new wall of revolution to take the place of the removed wall, and welding said new wall to the drum.

2. A method according to claim 1, wherein it consists in cutting the deformed wall in the middle of the local extra thickness, and in replacing it with a new wall that likewise includes a local extra thickness.

3. A method according to claim 1, wherein the new wall is welded to the drum by inertia friction welding or by electron beam welding.

4. A method according to claim 1, wherein, before or after the step of welding the wall, it includes a step consisting in machining the new wall so as to form thereon external annular wipers.

5. A method according to claim 1, wherein, after the welding step, it includes a step consisting in machining the welded zone so that its radial thickness is substantially equal to the radial thickness of the remainder of the wall.

6. A method according to claim 1, wherein the extra thickness is situated between outer annular wipers of the wall of revolution and a rotor disk.

7. A turbomachine compressor drum comprising at least two rotor disks on a common axis connected to each other and to an annular flange on the same axis via substantially cylindrical or frustoconical walls of revolution, wherein the wall of revolution connecting one of the disks to the annular flange includes at least one local annular extra thickness of material, through which the drum can be cut in the event of said wall becoming deformed, in order to remove and replace the wall.

8. A drum according to claim 7, wherein the extra thickness is situated between a rotor disk and outer annular wipers formed on the wall of revolution.

9. A drum according to claim 7, wherein the extra thickness presents a radial thickness lying in the range about 6 mm to 10 mm, with the radial thickness of the remainder of the wall being of the order of about 3 mm.

10. A drum according to claim 7, that is made of titanium.

11. A turbomachine, wherein the turbomachine includes at least one compressor drum according to claim 7.
